(19) United States
(12) Patent Application Publication
(10) Pub. No.: US 2026/0061726 A1
(43) Pub. Date: Mar. 5, 2026

(54) TRANSPARENCY SHELL OR TRANSPARENCY FILM FOR A VEHICLE TRANSPARENCY AND APPLICATION METHODS

(71) Applicant: PPG Industries Ohio, Inc., Cleveland, OH (US)

(72) Inventors: Eric Christopher Sasse, Los Angeles, CA (US); David Ingram Palermo, Pasadena, CA (US); Khushroo H. Lakdawala, Chatsworth, CA (US); Krishna Kamal Uprety, Valencia, CA (US); Tanvi Siraj Ratani, Allison Park, PA (US); Pauline June Han, Sylmar, CA (US)

(73) Assignee: PPG Industries Ohio, Inc., Cleveland, OH (US)

(21) Appl. No.: 19/105,662

(22) PCT Filed: Jun. 24, 2023
(86) PCT No.: PCT/US2023/069035

§ 371 Date: Feb. 21, 2025

Related U.S. Application Data
(60) Provisional application No. 63/373,341, filed on Aug. 24, 2022.

(51) Int. Cl. B32B 17/10

(52) U.S. Cl. CPC B32B 17/10211; B32B 17/1077; B32B 2255/10; B32B 2255/20; B32B 2255/26; B32B 2307/412; B32B 2605/006; B32B 2605/18

(57) ABSTRACT

A transparency shell for applying to a vehicle transparency including a central viewing region of the vehicle transparency and a peripheral region at least partially around the central viewing region, the transparency shell including: a bonding layer including a polyurethane interlayer, a polyvinyl interlayer, UV-curable adhesive, or a pressure sensitive adhesive; a transparency liner including a polycarbonate, poly(methyl methacrylate), polyurethane, glass, polyethylene terephthalate, biaxially textured polyethylene terephthalate, or a combination thereof over the bonding layer; and an inorganic active ply over the bonding layer comprising a transparent conductive layer, where the bonding layer of the transparency shell can be configured to be adhered or laminated to the central viewing region of the vehicle transparency.

### STATEMENT REGARDING FEDERALLY SPONSORED RESEARCH

This disclosure was made with Government support under Contract No. FA8650-18-D-5600 to the University of Dayton Research Institute (UDRI) and UDRI-PPG Subcontract No. RSC19077. The United States Government may have certain rights in this disclosure.

### FIELD OF THE DISCLOSURE

This disclosure relates to transparency shells and methods for applying transparency shells and, in particular, to transparency shells and methods for applying transparency shells to vehicle transparencies. This disclosure also relates to transparency films and methods for applying transparency films and, in particular, to transparency films and methods for applying transparency films to vehicle transparencies.

### BACKGROUND OF THE DISCLOSURE

Vehicles, such as aircrafts, include various transparencies to allow operators to view the surrounds of the vehicle. During operation of the vehicle, external conditions result in the deterioration of and/or damage to the external coating system of the vehicle transparency and/or to the vehicle transparency itself. Once the coating and/or vehicle transparency is damaged, the functionality of the vehicle transparency can be lost.

### SUMMARY OF THE DISCLOSURE

The disclosure can include a transparency shell for applying to a vehicle transparency including a central viewing region of the vehicle transparency and a peripheral region at least partially around the central viewing region, the transparency shell including: a bonding layer including a polyurethane interlayer, a polyvinyl interlayer, a UV-curable adhesive, or a pressure sensitive adhesive; a transparency liner including a polycarbonate, poly(methyl methacrylate), polyurethane, glass, polyethylene terephthalate, biaxially textured polyethylene terephthalate, glycol-doped polyethylene terephthalate, or a combination thereof over the bonding layer; and an inorganic active ply over the bonding layer comprising a transparent conductive layer, where the bonding layer of the transparency shell can be configured to be adhered or laminated to the central viewing region of the vehicle transparency.

The disclosure can also include a vehicle transparency including a central viewing region and a peripheral region at least partially around the central viewing region covered with the previously-described transparency shell.

The disclosure can also include a use of the previously-described transparency shell to repair a vehicle transparency.

The disclosure can also include a method for applying a transparency shell to a vehicle transparency including a central viewing region and peripheral regions, the method including: preparing the previously-described transparency shell, where the transparency liner can be pre-formed to a curvature that corresponds to a curvature of an outer surface of the central viewing region of the vehicle transparency; placing the transparency shell over the central viewing region of the vehicle transparency; and applying external pressure to at least a portion of the transparency shell to adhere or laminate the transparency shell to the vehicle transparency.

The disclosure can include a transparency film for a vehicle transparency including a central viewing region of the vehicle transparency and a peripheral region at least partially around the central viewing region, the transparency film including: an adhesive layer including a UV-curable and/or pressure sensitive adhesive; a transparency liner including a polyurethane, polyurea, polyethylene terephthalate, biaxially textured polyethylene terephthalate, glycol-doped polyethylene terephthalate, or a combination thereof over the adhesive layer; and an inorganic active ply over the adhesive layer comprising a transparent conductive layer, where the adhesive layer of the transparency film can be configured to be adhered to the central viewing region of the vehicle transparency.

The disclosure can also include a vehicle transparency including a central viewing region and a peripheral region at least partially around the central viewing region covered with the previously-described transparency film.

The disclosure can also include a use of the previously-described transparency film to repair a vehicle transparency.

The disclosure can also include a method for applying a transparency film to a vehicle transparency including a central viewing region and peripheral regions, the method including: preparing the previously-described transparency film; placing the transparency film over the central viewing region of the vehicle transparency; and applying an external pressure to at least a portion of the transparency film to adhere the transparency film to the vehicle transparency.

### BRIEF DESCRIPTION OF THE DRAWINGS

These and other features and characteristics of the present disclosure, as well as the methods of operation and functions of the related elements of structures and the combination of the parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only, and are not intended as a definition of the limit of the disclosure.

Further features and advantages will become apparent from the following detailed description made with reference to the drawings in which:

FIG. 1 is a diagram of an aircraft;

FIG. 2a is a cross-sectional view of a vehicle transparency;

FIG. 2b is a front view of a vehicle transparency;

FIG. 3 is a cross-sectional view of a transparency shell adhered or laminated to the vehicle transparency of FIG. 2;

FIG. 4 is a cross-sectional view of another transparency shell adhered or laminated to the vehicle transparency of FIG. 2;

FIG. 5 is a cross-sectional view of another transparency shell adhered or laminated to the vehicle transparency of FIG. 2;

FIG. 6 is a flowchart of a method for applying the transparency shell of FIGS. 3-5 to the vehicle transparency of FIG. 2;

FIG. 7 is a cross-sectional view of a transparency film adhered to the vehicle transparency of FIG. 2;

FIG. 8 is a cross-sectional view of another transparency film adhered to the vehicle transparency of FIG. 2;

FIG. 9 is a cross-sectional view of another transparency film adhered to the vehicle transparency of FIG. 2;

FIG. 10 is a cross-sectional view of another transparency film adhered to the vehicle transparency of FIG. 2;

FIG. 11 is a cross-sectional view of another transparency film adhered to the vehicle transparency of FIG. 2;

FIG. 12 is a cross-sectional view of another transparency film adhered to the vehicle transparency of FIG. 2; and

FIG. 13 is a flowchart of a method for applying the transparency film of FIGS. 7-12 to the vehicle transparency of FIG. 2.

### DESCRIPTION OF THE DISCLOSURE

For the purposes of the following detailed description, it is to be understood that the disclosure can assume various alternative variations and step sequences, except where expressly specified to the contrary. Unless indicated to the contrary, the numerical parameters set forth in the following specification and attached claims are approximations that can vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

As used herein, the terms “upper”, “lower”, “top”, “bottom”, and derivatives thereof shall relate to the disclosure as it is oriented in the drawing figures. However, it is to be understood that the disclosure can assume various alternative orientations and, accordingly, such terms are not to be considered as limiting. Additionally, as used herein, the terms “over”. “formed over”, “provided over”, and the like mean formed and/or provided over but not necessarily in contact with the surface. For example, a layer over a transparency liner does not preclude the presence of one or more other layers, same or different, from being located between the layer and the transparency liner.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include any and all sub-ranges between and including the recited minimum value of 1 and the recited maximum value of 10, that is, all subranges beginning with a minimum value equal to or greater than 1 and ending with a maximum value equal to or less than 10, and all subranges in between, e.g., 1 to 6.3, or 5.5 to 10, or 2.7 to 6.1.

In this application, the use of the singular includes the plural and the plural encompasses singular, unless specifically stated otherwise. In addition, in this application, the use of “or” means “and/or” unless specifically stated otherwise, even though “and/or” can be explicitly used in certain instances. As used herein, the singular form of “a”, “an”, and “the” include plural referents unless the context clearly dictates otherwise. For example, although the disclosure has been described in terms of “a” repair shell and “an” inorganic active ply, one or more of any of these components or any other components recited herein can be used according to the present disclosure. Also, as used herein, the term “polymer” is meant to refer to prepolymers, oligomers, and both homopolymers and copolymers. The term “resin” is used interchangeably with “polymer”.

As used herein, the transitional term “comprising” (and other comparable terms, e.g., “containing” and “including”) is “open-ended” and open to the inclusion of unspecified matter. Although described in terms of “comprising”, the terms “consisting essentially of” and “consisting of” are also within the scope of the disclosure.

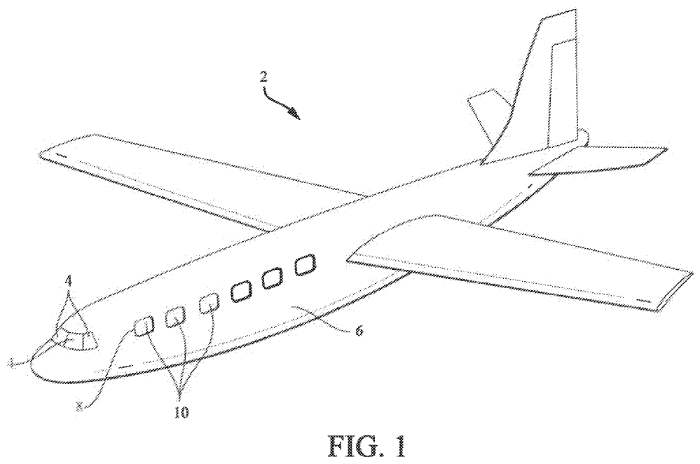

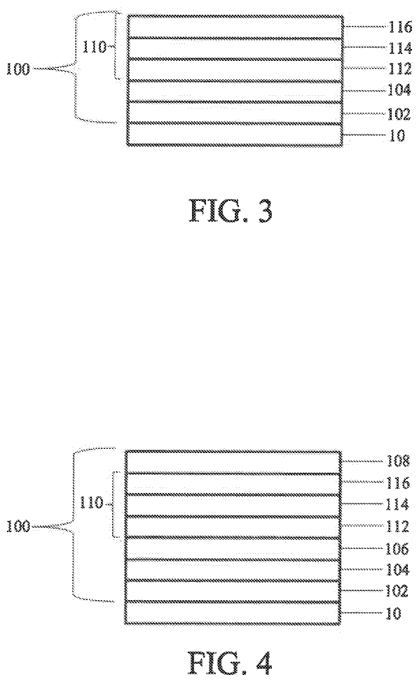

FIGS. 3-5 illustrate a transparency shell 100 that can be applied to a transparency 10 (shown in FIG. 1) of a vehicle. As used herein, a “transparency shell” can refer to a structure that comprises a pre-formed transparency liner 104 such that an inner surface of the transparency shell 100 comprises a curvature that corresponds to an outer surface 14 of the vehicle transparency 10. The transparency shell 100 can be configured to protect at least a portion of the vehicle transparency 10. The transparency shell 100 can be configured to protect and cover the entire outer surface 14 of a vehicle transparency 10 or a portion of the outer surface 14 of the vehicle transparency 10, such as of a central viewing region 24 of the vehicle transparency 10. The transparency shell 100 can be configured to repair a damaged portion 28 of the vehicle transparency 10 to restore the functionality of the vehicle transparency 10 without replacing the entire transparency.

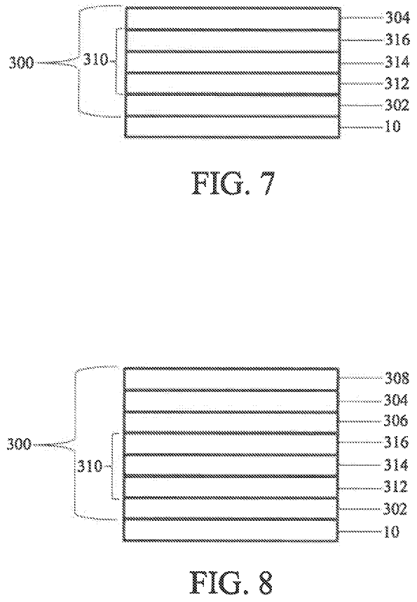

FIGS. 7-12 illustrate a transparency film 300. The transparency film 300 can be a flexible film that can be configured to be applied to a portion of the outer surface 14 of the vehicle transparency 10. The transparency film 300 can be configured to protect a portion of the outer surface 14 of the vehicle transparency 10, such as a portion of the central viewing region 24 of the vehicle transparency 10. The transparency film 300 can be configured to repair a damaged portion 28 of the vehicle transparency 10 to restore functionality of the vehicle transparency without replacing the entire transparency.

The present disclosure includes transparency shells 10 and transparency films 300 that are configured to be applied to a transparency, such as a transparency of a vehicle (referred to as a vehicle transparency 10). In the present disclosure, the term “vehicle” is used in its broadest sense and includes all types of aerospace vehicles including aircraft and spacecraft, as well as watercraft and ground vehicles. For example, the vehicle can be an aircraft such as, for example, airplanes (e.g., private airplanes, and small, medium, or large commercial passenger, freight, and military airplanes), helicopters (e.g., private, commercial, and military helicopters), spacecraft vehicles (e.g., rockets and other spacecraft), and the like. The vehicle can also include a ground vehicle such as, for example, animal trailers (e.g., horse trailers), all-terrain vehicles (ATVs), cars, trucks, buses, vans, heavy duty equipment, tractors, golf carts, motorcycles, bicycles, snowmobiles, trains, railroad cars, and the like. The vehicle can also include watercraft such as, for example, ships, boats, hovercrafts, and the like.

With reference to FIG. 1, a winged aircraft 2, which can include the transparencies described herein, includes one or more windshields 4 positioned adjacent the fore or front end thereof. Each windshield 4 desirably has a form that conforms to the shape of the corresponding aircraft 2 where each windshield 4 is installed. To facilitate attachment to the aircraft 2, each windshield 4 includes a support frame 6 that surrounds the windshield and provides a mechanical interface between the windshield 4 and the body of aircraft 2 for connecting windshield 4 to aircraft 2. The aircraft 2 also includes a plurality of passenger windows 8 arranged side-by-side extending along the fuselage of the aircraft 2. As described herein, the windshield 4 and/or passenger windows 8 can include a coating covering a portion of a surface of the window 8 or windshield 4 for heating the surface of the windshield 4 and/or window 8. As used herein, a coating can be a layer, film, membrane, or laminated material applied to a surface of the windshield 4 or window 8 by any convenient process or technique, such as spraying or painting. The coating can be applied prior to mounting the windshield 4 or window 8 to the aircraft 2 or after the windshield 4 or window 8 is in place on the aircraft 2.

The windshields 4 or windows 8 shown in FIG. 1 can each include one or more transparencies 10 connected to the aircraft frame 6. The disclosure is not limited to any particular type of transparency 10 and can include a windshield, canopy, passenger window, or any other vehicle transparency, as are known in the art. A vehicle transparency refers to a substrate used in a vehicle that has a viewing region with a visible light transmittance suitable for the vehicle transparency. The visible light transmittance of the vehicle transparency can depend on the use of the vehicle transparency in the vehicle. A vehicle transparency can be used as a windshield and viewed through to operate the vehicle can have a higher visible light transmittance than a passenger window.

The vehicle transparency 10 can be an aircraft transparency. The aircraft transparency 10 can be an aircraft windshield, e.g., but not limited to, a right side windshield, a left side windshield, a right front windshield, or a left front windshield of an aircraft. The aircraft transparency 10 can be a cabin window or a cockpit window panel in a commercial aircraft. The aircraft transparency 10 can be an aircraft canopy.

The transparencies 10 described herein can also be used as windows for other applications including windows for other types of vehicles, such as land vehicles (e.g., trucks, busses, trains, or automobiles) or water vehicles (e.g., boats or submarines). The transparencies 10 described herein can also be used for providing windows for buildings, such as residential buildings or commercial buildings.

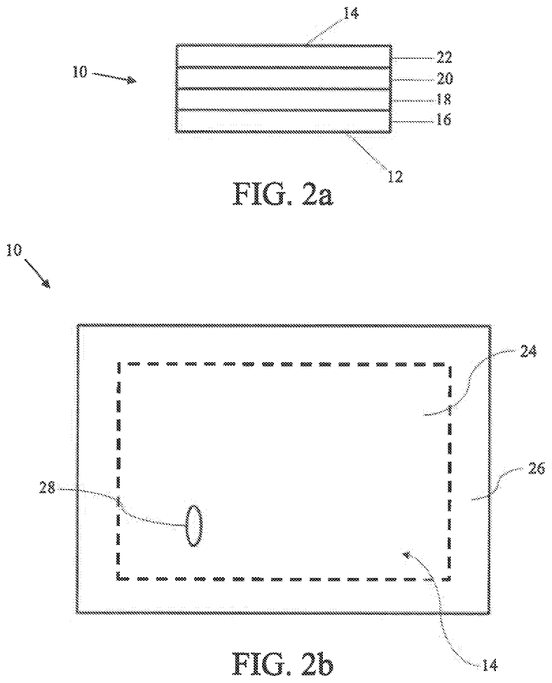

Referring to FIGS. 2a-2b, the vehicle transparency 10 can comprise a central viewing region 24 and a peripheral region 26 at least partially around the central viewing region 24 covered with the transparency shell 100. The vehicle transparency 10 comprises an inner surface 12 and an outer surface 14. The vehicle transparency 10 may be positioned such that the inner surface 12 faces the inside of the vehicle and the outer surface 14 faces away from the vehicle. The vehicle transparency 10 can comprise a first sheet 16 and a second sheet 20. The first sheet 16 and second sheet 20 can be a first glass sheet 16 and a second glass sheet 20. The first sheet 16 and the second sheet 20 can be joined together by an interlayer 18 or an ultraviolet (UV)-curable and/or pressure sensitive adhesive 18. The interlayer 18 can be a vinyl interlayer 18 or a urethane interlayer 18. The vehicle transparency 10 can further comprise a moisture seal on the peripheral region 26 of the vehicle transparency. The vehicle transparency 10 can comprise a curvature. While the vehicle transparency 10 can be made with a variety of particular curvatures within the scope of the present disclosure, the vehicle transparency 10 generally comprises a curvature that conforms to the required curvature of the vehicle where the vehicle transparency 10 can be installed.

The vehicle transparency 10 can further comprise a functional coating 22 over the second sheet 20. A functional coating refers to a coating that is not solely aesthetic and that imparts a particular functionality, such as conductivity, optical, p-static, and/or the like, to the vehicle transparency. The functional coating 22 can be a conductive coating that imparts conductive continuity across the vehicle transparency 10.

The vehicle transparency 10 can comprise a damaged portion 28 within the central viewing region 24. The damaged portion 28 in the central viewing region 24 of the vehicle transparency 10 can be caused by debris, collisions, weather and/or other environmental factors, aging of the vehicle transparency 10, and/or the like. When a vehicle transparency 10 is damaged, the damaged portion 28 needs to be repaired immediately to prevent further damage to the vehicle transparency 10 that can create a hazard for the vehicle and/or to the operator of the vehicle. When the damaged portion 28 is present in the central viewing region 24 of the vehicle transparency 10, the damaged portion 28 can be repaired in a way that does not induce optical distortion through the central viewing region 24 of the vehicle transparency 10 so that the vehicle can still be safely operated. The damaged portion 28 of the central viewing region 24 can inhibit conductive continuity of a functional coating 22 at the damaged portion 28 of the central viewing region 24 of the vehicle transparency 10.

FIGS. 3-5 illustrate the transparency shell 100 configured to be applied to a transparency, such as a transparency of a vehicle (referred to as a vehicle transparency 10). The transparency shell 100 of the present disclosure can be configured to be applied to the outer surface 14 of the vehicle transparency 10 to protect portions of the transparency and/or to repair damaged portions 28 of the vehicle transparency 10. The transparency shell 100 can be applied to the entire outer surface 14 of the vehicle transparency 10. Alternatively, the transparency shell 100 can be applied to a portion of the outer surface 14 of the vehicle transparency 10, such as a damaged portion 28 of the vehicle transparency 100.

Referring to FIGS. 3-5, the transparency shell 100 comprises a bonding layer 102. The bonding layer 102 comprises a polyurethane interlayer, a polyvinyl interlayer, or a UV-curable and/or pressure sensitive adhesive. The bonding layer 102 can be configured to be adhered or laminated to the central viewing region 24 of the vehicle transparency 10. The bonding layer 102 can comprise a polyurethane interlayer or a polyvinyl interlayer and can be configured to be laminated to the central viewing region 24 of the vehicle transparency 10. The bonding layer 102 can comprise a UV-curable and/or pressure sensitive adhesive and can be configured to be adhered to the central viewing region 24 of the vehicle transparency 10. The UV-curable and/or pressure sensitive adhesive can be selected based on, for example, the peel strength, adhesive strength, and/or cosmetic appearance of the UV-curable and/or pressure sensitive adhesive. As used herein, a “pressure sensitive adhesive” can refer to a non-reactive adhesive that forms a bond between the adhesive and a surface when a pressure of at least 10 psi is applied, such as the amount of pressure that can be applied by hand or using a manual pressing tool (e.g., a squeegee). A “UV-curable adhesive” can refer to an adhesive that cures when exposed to light of an appropriate wavelength and intensity, such as to light in the UV region of the electromagnetic spectrum. The bonding layer 102 may have a thickness of less than 50 microns, or less than 25 microns, or less than 10 microns, or less than 5 microns. The bonding layer 102 may have a thickness of at least 0.5 micron, or at least 1 micron. The bonding layer 102 may have a thickness in the range of from 0.5 micron to 50 microns, or from 1 micron to 25 microns, or from 1 micron to 10 microns, or from 1 micron to 5 microns.

The transparency shell 100 further comprises a transparency liner 104 over the bonding layer 102. The transparency liner 104 can comprise a polycarbonate, poly(methyl methacrylate), polyurethane, glass, polyethylene terephthalate, biaxially textured polyethylene terephthalate, glycol-doped polyethylene terephthalate, or a combination thereof. The transparency liner 104 can be pre-formed to a curvature such that the inner surface of the transparency shell matches the curvature of the outer surface of the vehicle transparency 10, such as the outer surface of the central viewing region 24 of the vehicle transparency 10, such as a damaged portion 28 of the central viewing region 24 of the vehicle transparency 10.

The transparency liner 104 can comprise precipitation static (p-static) capabilities. P-static capabilities refer to the transparency liner 104 having anti-static and/or static-dissipative properties. In particular, the transparency liner 104 can be configured to drain or dissipate static charges that collect in the transparency during operation of the vehicle. Due to the p-static capabilities of the transparency liner 104, the transparency 10 may have a resistance of less than or equal to 10⁶Ω/□ in plane, and a resistance of less than or equal to 10¹²Ω/□ out-of-plane. As used herein, p-static capabilities can be tested on a 12″×12″ transparency coated on one side with an antistatic coating (i.e., topcoat) by applying a conductive chomerics tape CFT-18-101-0100, commercially available from Parker Chomerics (Woburn, MA), over the surface of the topcoat of the transparency. The transparent conductive layer of the transparency shell and the chomerics tapc over the transparency serve as two electrodes during p-static testing. Conductive wires are used to make a complete circuit, with a first conductive wire between the transparent conductive layer and a Digital Precision Multimeter Model No. 8846A manufactured by Fluke Corporation (Everett, WA), a second conductive wire between the chomerics tape and HYPOT III AC/DC Withstand Voltage Tester Model No. 3665 manufactured by Associated Research (Lake Forest, IL), and a third conductive wire between the aforementioned multimeter and voltage tester. The voltage tester was used as a power supply to apply the voltage in order to achieve desired leakage currents (μA) through the topcoat. The current during the testing is monitored using the multimeter. The temperature of the transparency was monitored using a thermocouple attached to the uncoated side of the transparency. P-static testing is carried out at 20° F., −20° F., and 40° F. P-static failure is indicated by current fluctuations of +/−20% as a result of the breakdown of the topcoat of the transparency.

The transparency liner 104 can have a thickness of at least 1 mil, or at least 10 mil, or at least 20 mil, or at least 50 mil, or at least 80 mil. The transparency liner 104 can have a thickness of up to 200 mil, or up to 175 mil, or up to 150 mil, or up to 125 mil, or up to 100 mil. The transparency liner 104 can have a thickness in the range of from 1 mil to 200 mil, or in the range of from 10 mil to 200 mil, or in the range of from 50 mil to 200 mil, or in the range of from 10 mil to 175 mil, or in the range of from 20 mil to 150 mil, or in the range of from 50 mil to 125 mil, or in the range of from 80 mil to 100 mil.

The transparency shell 100 can further comprise an inorganic active ply 110 over the transparency liner 104. As used herein, a “ply”, such as the inorganic active “ply”, includes one or more layers. The inorganic active ply 110 comprises a transparent conductive layer 114. As used herein, a “transparent conductive layer” can refer to a layer having greater than 80% transmittance of visible light and which can be formed from electrically conductive materials. The transparent conductive layer 114 can comprise gold, silver, copper, nickel, indium tin oxide, aluminum-doped zinc oxide, fluorine-doped tin oxide, palladium, platinum, alloys of palladium and silver, or combinations thereof. The transparent conductive layer 114 can electrically contact conductive layers of a functional coating 22 on the central viewing region 24 of the vehicle transparency 10. The transparent conductive layer 114 can be in direct contact with conductive layers of a functional coating 22. Alternatively, one or more intervening layers may be positioned between the transparent conductive layer 114 and conductive layers of a functional coating 22 with the transparent conductive layer 114 electrically contacting conductive layers of the functional coating 22 through the intervening layers. If intervening layers are present between the transparent conductive layer 114 and the conductive layers of the functional coating 22, the intervening layers may be sufficiently conductive such that the transparent conductive layer 114 electrically contacts conductive layers of the functional coating 22. The bonding layer 102 may include a conductive UV-curable and/or pressure sensitive adhesive, such as an adhesive layer that comprises carbon nanotubes, graphene, conductive dopants (e.g., silver and/or gold), or combinations thereof. A conductive UV-curable and/or pressure sensitive adhesive can aid in the electrical contact between the transparent conductive layer 114 and conductive layers of the functional coating 22. The transparency shell 100 may overlap the central viewing region 24 of the transparency 10 by at least 1 cm beyond the damage portion 28 in each direction to allow conductive continuity between the transparent conductive layer 114 and the conductive layers of the functional coating 22.

The inorganic active ply 110 can comprise biaxially textured polyethylene terephthalate. The inorganic active ply 110 can comprise a first dielectric layer 112. The first dielectric layer 112 can be under the transparent conductive layer 114. The inorganic active ply 110 can comprise a second dielectric layer 114. The second dielectric layer 116 can be over the transparent conductive layer 114. The inorganic active ply 110 can comprise a transparent conductive layer 114 and a dielectric layer 116 over the transparent conductive layer 114. The inorganic active ply 110 can comprise a first dielectric layer 112, a transparent conductive layer 114 over the first dielectric layer 112, and a second dielectric layer 116 over the transparent conductive layer 114. The inorganic active ply 110 can comprise a transparent conductive layer 114 positioned between at least two dielectric layers 112, 116. The dielectric layers 112, 116 of the inorganic active ply 110 can comprise titanium oxide, aluminum-doped zinc oxide, silicon oxide, tin oxide, indium-doped tin oxide, antimony-doped tin oxide, alumina, silicon nitrate, hafnium oxide, cerium oxide, yttrium oxide, yttrium-stabilized zirconia, zinc oxide, magnesium oxide, or a combination thereof. The dielectric layers 112, 116 of the inorganic active ply 110 can comprise the same material as each other. Alternatively, the dielectric layers 112, 116 of the inorganic active ply 110 can comprise different materials from each other.

The inorganic active ply 110 can comprise a patterned conductive layer or grid. A patterned conductive layer can refer to a layer or layers formed by passing a sputtering target over the transparency shell 100 to apply the material(s) of the inorganic active ply 110 to the transparency shell 100 to control thickness and/or location of the deposited layer(s). As a result, the pattern for moving the target can be selected to apply more material and/or layers to a portion of the transparency shell 100 and to apply less material and/or layers of the material(s) to other portions of the transparency shell 100. Controlled movement of the sputtering target can be performed according to predetermined patterns to produce the inorganic active ply 110 having desired thickness and power density variability to obtain certain benefits. A patterned conductive grid can refer to a grid formed from elongated wires or conductive traces embedded in or over the transparency shell 100 applied in a pattern to control or optimize heating of different areas of the transparency shell 100.

The inorganic active ply 110 can provide additional properties to the transparency shell 100, such as, but not limited to, electromagnetic interference shielding, rain repellence and hydrophilicity, abrasion resistance, and/or chemical resistance. The transparency shell 100 can comprise more than one inorganic active ply 110, such as at least two inorganic active plies 110, such as at least three inorganic active plies 110, or even more.

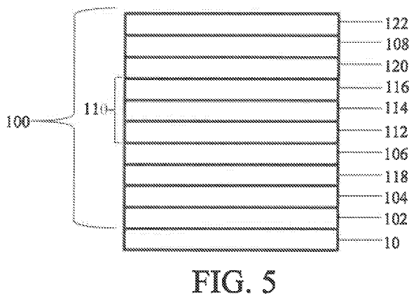

Referring to FIGS. 4 and 5, the transparency shell 100 can further comprise a basecoat layer 106 over the bonding layer 102. If a basecoat layer 106 is present, the previously described inorganic active ply 110 can be over the basecoat layer 106. The basecoat layer 106 can comprise a silicone-based polymer, a silicon and epoxy based polymer. (meth)acrylate, an epoxy and acrylic based polymer, polyurethane, or a combination thereof. The basecoat layer 106 can be over the transparency liner 104. The basecoat layer 106 can enable conductivity of the inorganic active ply 110.

The transparency shell 100 can further comprise a polyurethane protective layer 108 over the transparency liner 104. The polyurethane protective layer 108 can comprise a polyurethane. For example, the polyurethane protective layer 108 can comprise a polyurethane that can be formed from a polyol and an isocyanate. The polyurethane protective layer 108 can be over the inorganic active ply 110. The polyurethane protective layer 108 can protect the transparency shell 100 from mechanical and/or chemical damage from the surrounding environment.

Referring to FIG. 5, the transparency shell 100 can comprise a rain repellant and/or hydrophobic layer 122. The rain repellant and/or hydrophobic layer 122 can be over the polyurethane protective layer 108. The rain repellant and/or hydrophobic layer 122 can comprise polydimethylsiloxane (PDMS), a hydrocarbon, a polyurethane, wax, and/or an inorganic material such as hafnium oxide, cerium oxide, yttrium-stabilized zirconia, or a combination thereof. The rain repellant and/or hydrophobic layer 122 can prevent rain, moisture, and other sources of water from penetrating and damaging the transparency shell 100 and the vehicle transparency 10 thereunder.

The transparency shell 100 can comprise a first tie coat layer 118. The first tie coat layer can comprise an acrylic, a polyurethane, a polysiloxane, or a combination thereof. The first tie coat layer 118 can be over the transparency liner 104. The first tie coat layer 118 can be under the basecoat layer 106. The first tie coat layer 118 can be over the transparency liner 104 and under the basecoat layer 106. If a first tie coat layer 118 is present, the previously-described basecoat layer 106 can be over the first tie coat layer 118. The first tie coat layer 118 can increase adhesion to adjacent layers of the transparency shell 100 and/or increase flexibility of the transparency shell 100. The increased adhesion and flexibility can help dissipate mechanical and thermal energy by movement of the transparency shell 100 and other stressors. In this way, the first tie coat layer 118 can increase compatibility of the adjacent layers of the transparency shell 100.

The transparency shell 100 can comprise a second tie coat layer 120. The second tie coat layer 120 can comprise an acrylic, a polyurethane, a polysiloxane, or a combination thereof. The second tie coat layer 120 can be over the inorganic active ply 110. The second tie coat layer 120 can be under the polyurethane protective layer 108. The second tie coat layer 120 can be over the inorganic active ply 110 and under the polyurethane protective layer 108. If a second tie coat layer 120 is present, the previously-described polyurethane protective layer 108 can be over the second tie coat layer 120. The second tie coat layer 120 can increase adhesion to adjacent layers of the transparency shell 100 (e.g., the inorganic active ply 110 and polyurethane protective layer 108) and/or increase flexibility of the transparency shell 100. The second tie coat layer 120 can help to protect a layer positioned thereunder, such as the inorganic active ply 110.

The layers of the transparency shell 100 can be provided in a variety of configurations and arrangements within the scope of the present disclosure determined, for example, based on functional requirements of particular vehicle transparencies, manufacturing requirements for the shell and/or transparency, or other considerations. As shown in FIG. 3, the transparency shell 100 can comprise the bonding layer 102, the transparency liner 104 over the bonding layer 102, and the inorganic active ply 110 over the transparency liner 104. Alternatively, as shown in FIG. 4, the transparency shell 100 can comprise the bonding layer 102, the transparency liner 104 over the bonding layer 102, the basecoat layer 106 over the transparency liner 104, the inorganic active ply 110 over the basecoat layer 106, and the polyurethane protective layer 108 over the inorganic active ply 110. The transparency shell 100 can further comprise a rain repellant and/or hydrophobic layer 122 over the polyurethane protective layer 108.

Alternatively, as shown in FIG. 5, the transparency shell 100 can comprise the bonding layer 102, the transparency liner 104 over the bonding layer 102, the first tie coat layer 118 over the transparency liner 104, the basecoat layer 106 over the first tie coat layer 118, the inorganic active ply 110 over the basecoat layer 106, and the polyurethane protective layer 108 over the inorganic active ply 110. The transparency shell 100 can comprise the bonding layer 102, the transparency liner 104 over the bonding layer 102, the first tie coat layer 118 over the transparency liner 104, the basecoat layer 106 over the first tie coat layer 118, the inorganic active ply 110 over the basecoat layer 106, the second tie coat layer 120 over the inorganic active ply 110, and the polyurethane protective layer 108 over the second tie coat layer 120. The transparency shell 100 can further comprise a rain repellant and/or hydrophobic layer 122 over the polyurethane protective layer 108.

While transparency shells can be made in a variety of shapes and sizes within the scope of the present disclosure, as previously described, the transparency shell 100 generally can be shaped to correspond to a curvature of the vehicle transparency 10 to which it will be adhered and sized to cover at least a damaged portion 28 of the vehicle transparency 10. More specifically, the curvature of the transparency shell 100 can correspond to a curvature of an outer surface of the central viewing region 24 of the vehicle transparency 10. For example, for an aircraft transparency 10, such as an aircraft canopy, the transparency shell 100 can comprise a curvature that corresponds to a curvature of an outer surface of the central viewing region 24 of the aircraft transparency 10, such as the aircraft canopy. The corresponding curvature between the vehicle transparency 10 and the transparency shell 100 allows the transparency shell 100 to be adhered or laminated to the central viewing region 24 of the vehicle transparency 10. The transparency liner 104 can be pre-formed to a curvature that corresponds to an outer surface of the central viewing region 24 of the vehicle transparency 10, such that the transparency shell 100 comprises a curvature that corresponds to a curvature of an outer surface of the central viewing region 24 of the vehicle transparency 10.

The transparency shell 100 may not induce and/or can reduce optical distortion through the central viewing region 24 of the vehicle transparency 10 when adhered or laminated to the central viewing region 24 of the vehicle transparency 10. For example, the transparency shell 100 may not induce and/or can reduce optical distortion through the central viewing region 24 of the vehicle transparency 10 such that, after the transparency shell 100 has been adhered or laminated to the central viewing region 24 of the vehicle transparency 10, the vehicle comprising the vehicle transparency 10 can be safely operated and the central viewing region 24 of the vehicle transparency 10 meets optical standards and guidelines for operation of the vehicle. For example, the transparency shell 100 may not substantially negatively affect, and can improve, light transmission, distortion and defraction, haze, and/or the like of the vehicle transparency 10. Substantially negatively affect refers to a negative change in an aforementioned property by 10% or more, where negative change is a change in the quantified value of a property that moves the quantified value of the property away from the desired quantified value of the property for the vehicle transparency 10.

The transparency shell 100 can be configured to be adhered or laminated to the damaged portion 28 of the central viewing region 24 of the vehicle transparency 10. By adhering or laminating the transparency shell 100 to the damaged portion 28 of the central viewing region 24 of the vehicle transparency 10, the transparency shell 100 can repair the damaged portion 28 of the central viewing region 24 of the vehicle transparency 10. For example, a use of the transparency shell 100 can be to repair the vehicle transparency 10. The transparency shell 100 may not induce and/or can reduce optical distortion through the damaged portion 28 of the central viewing region 24 of the vehicle transparency 10 compared to an optical distortion through the damaged portion 28 of the central viewing region 24 of the vehicle transparency 10 without the transparency shell 100. The transparency shell 100 can repair and provide conductive continuity of a functional coating 22 at the damaged portion 28 of the central viewing region 24 of the vehicle transparency 10.

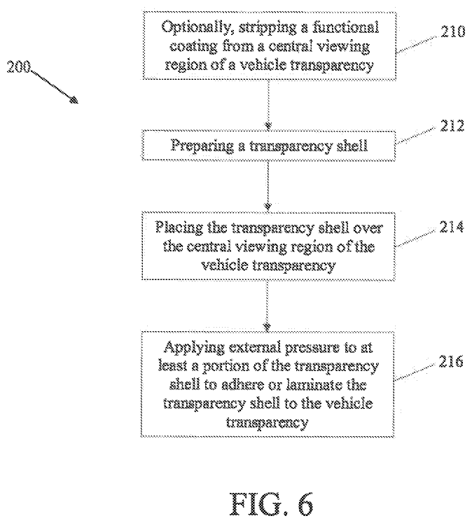

FIG. 6 illustrates steps of a method 200 for applying the transparency shell 100 to a vehicle transparency 10 comprising a central viewing region 24 and peripheral regions 26. The central viewing region 24 of the vehicle transparency 10 may be coated or uncoated prior to placing of the transparency shell 100. As previously described, the transparency shell 100 can be applied to the vehicle transparency 10 to repair the damaged portion 28 of the central viewing region 24 of the vehicle transparency 10 without removing the vehicle transparency 10 from the vehicle. This allows for the damaged portion 28 of the central viewing region 24 of the vehicle transparency 10 to be repaired at any time when the vehicle transparency 10 is accessible, and does not require expensive and time consuming processes of removing the vehicle transparency 10 and moving the vehicle transparency 10 to a repair location or replacing the vehicle transparency 10 entirely.

With reference to FIG. 6, when a functional coating 22 is present, the method 200 optionally comprises, at step 210, initially stripping a functional coating 22 from the central viewing region 24 in order to prepare the transparency 10 to be repaired. The functional coating 22 may be stripped from the central viewing region 24 of the vehicle transparency 10 by various methods, such as with acid and/or by a mechanical tool.

At step 212, the method 200 further comprises preparing a transparency shell 100. The transparency shell 100 can be any transparency shell 100 as described above. The transparency liner 104 of the transparency shell 100 can be pre-formed to a curvature such that the inner surface of the transparency shell 100 comprises a curvature that corresponds to a curvature of an outer surface of the central viewing region 24 of the vehicle transparency 10. The transparency liner 104 of the transparency shell 100 can be pre-formed by placing the transparency liner 104 over a tool or mold that corresponds to the desired pre-formed shape for the transparency liner 104, such as corresponding to the curvature of an outer surface of the central viewing region 24 of the vehicle transparency 10, and forming the transparency liner 104 to the shape of the tool or mold. During the preparing step 212, the layer(s) of the transparency shell 100 may be sequentially applied over the pre-formed transparency liner 104 to obtain the transparency shell 100 with layers in a specified order. Layer(s) of the transparency shell 100 that are positioned under the pre-formed transparency liner 104 may be sequentially applied under the pre-formed transparency liner 104. The layers of the transparency shell 100 may be applied to a pre-formed transparency liner 104 in any way known in the art. The transparency liner 104 may be pre-formed to a curvature such that the inner surface of the transparency liner 104 comprises a curvature that corresponds to a curvature of an outer surface of the central viewing region 24 of the vehicle transparency 10. The polyurethane protective layer 108, the basecoat layer 106, the first tie coat layer 118, and/or the second tie coat layer 120 may each independently be applied to the pre-formed transparency liner 104, either over or under depending on the specific positioning of the layer, using any technique known in the art. The polyurethane protective layer 108, the basecoat layer 106, the first tie coat layer 118, and/or the second tie coat layer may each independently be applied to the pre-formed transparency liner 104, cither over or under depending on the specific positioning of the layer, by flow coating technique. The inorganic active ply 110 and layers thereof may be applied to the pre-formed transparency liner 104, either over or under depending on the specific position of the ply and/or layer, using any technique known in the art, such as magnetic sputter vacuum deposition (MSVD). The bonding layer 102 may be applied under the pre-formed transparency liner 104 using any technique known in the art, such as roll coating, flow coating, brushing, and/or the like.

At step 214, the method 200 further comprises placing the transparency shell 100 over the prepared central viewing region 24 of the vehicle transparency 10. The placing of the transparency shell 100 may comprise placing the transparency shell 100 over an uncoated central viewing region 24 and peripheral regions 26 of the vehicle transparency 10. The placing of the transparency shell 100 may comprise placing the transparency shell 100 over a functional coating 22 on the central viewing region 24 and peripheral regions 26 of the vehicle transparency 10. The placing of the transparency shell 100 may comprise placing transparency shell 100 over the central viewing region 24 and peripheral regions 26 of the vehicle transparency 10, where a functional coating 22 had been previously stripped from the central viewing region 24 of the vehicle transparency 10 prior to the placing of the vehicle transparency 10.

Placing the transparency shell 100 can also comprise placing the shell 100 over a damaged portion 28 of the central viewing region 24 of the vehicle transparency 10. The placing of the transparency shell 100 over the damaged portion 28 of the central viewing region 24 of the vehicle transparency 10 may not induce and/or may reduce optical distortion through the damaged portion 28 of the central viewing region 24 compared to an optical distortion through the damaged portion 28 of the central viewing region 24 of the vehicle transparency 10 prior to the placing of the transparency shell 100. The transparency shell 100 may repair and provide conductive continuity of a functional coating 22 at the damaged portion 28 of the central viewing region 24 of the vehicle transparency 10.

At step 216, the method 200 further comprises applying external pressure to at least a portion of the transparency shell 100 for a pressure sensitive adhesive and/or applying radiation from a UV source to cure for a UV-curable adhesive to adhere or laminate the transparency shell 100 to the vehicle transparency 10. The adhering or laminating the transparency shell 100 to the vehicle transparency 10 may not induce and/or can reduce optical distortion through the central viewing region 24 of the vehicle transparency 10.

FIGS. 7-12 illustrate a transparency film 300 configured to be applied to a transparency, such as a transparency of a vehicle (referred to as a vehicle transparency 10). As with the previously described transparency shells, the transparency film 300 of the present disclosure can be configured to be applied to the outer surface 14 of the vehicle transparency 10 to protect portions of the transparency and/or to repair damaged portions 28 of the vehicle transparency 10. The transparency film 300 may be non-stretchable. As used herein, a “non-stretchable” transparency film 300 means that the surface area of the transparency film 300 does not increase by more than 1%, such as 0.5%, under an applied force. The transparency film 300 comprises an adhesive layer 302. The adhesive layer 302 can comprise a UV-curable and/or pressure sensitive adhesive. The adhesive layer 302 can be configured to be adhered to the central viewing region 24 of the vehicle transparency 10. The UV-curable and/or pressure sensitive adhesive can be selected based on, for example, the peel strength, adhesive strength, and/or cosmetic appearance of the UV-curable and/or pressure sensitive adhesive. As used herein, a “pressure sensitive adhesive” can refer to a non-reactive adhesive that forms a bond between the adhesive and a surface when a pressure of at least 10 psi is applied, such as the amount of pressure that may be applied by hand or using a tool such as a squeegee. The UV-curable and/or pressure sensitive adhesive may have a thickness of from 25 microns to 50 microns. The adhesive layer 302 may have a thickness of less than 50 microns, or less than 25 microns, or less than 10 microns, or less than 5 microns. The adhesive layer 302 may have a thickness of at least 0.5 micron, or at least 1 micron. The adhesive layer 302 may have a thickness in the range of from 0.5 micron to 50 microns, or from 1 micron to 25 microns, or from 1 micron to 10 microns, or from 1 micron to 5 microns.

The transparency film 300 further comprises a transparency liner 304 over the adhesive layer 302. The transparency liner 304 can be over the inorganic active ply 310. The transparency liner 304 can comprise a polyurethane, polyurea, polyethylene terephthalate, biaxially textured polyethylene terephthalate, glycol-doped polyethylene terephthalate, or a combination thereof. The transparency liner 304 can be flexible at standard temperature (i.e., 20° C.-25° C.) and pressure (e.g., 1 atm), such that the transparency film 300 can conform to the curvature of the outer surface 14 of the vehicle transparency 10.

The transparency liner 304 can comprise p-static capabilities. As previously described, p-static capabilities refer to the transparency liner 304 having anti-static and/or static-dissipative properties, and being configured to drain or dissipate static charges that collect in the transparency during operation of the vehicle. Due to the p-static capabilities of the transparency liner 304, the transparency 10 may have a resistance of less than or equal to 10⁶Ω/□ in plane, and a resistance of less than or equal to 10¹²Ω/□ out-of-plane. As used herein, p-static capabilities can be tested on a 12″×12″ transparency coated on one side with an antistatic coating (i.e., topcoat) by applying a conductive chomerics tape CFT-18-101-0100, commercially available from Parker Chomerics (Woburn. MA), over the surface of the topcoat of the transparency. The transparent conductive layer of the transparency film and the chomerics tape over the transparency serve as two electrodes during p-static testing. Conductive wires are used to make a complete circuit, with a first conductive wire between the transparent conductive layer and a Digital Precision Multimeter Model No. 8846A manufactured by Fluke Corporation (Everett, WA), a second conductive wire between the chomerics tape and HYPOT III AC/DC Withstand Voltage Tester Model No. 3665 manufactured by Associated Research (Lake Forest, IL), and a third conductive wire between the aforementioned multimeter and voltage tester. The voltage tester was used as a power supply to apply the voltage in order to achieve desired leakage currents (μA) through the topcoat. The current during the testing is monitored using the multimeter. The temperature of the transparency was monitored using a thermocouple attached to the uncoated side of the transparency. P-static testing is carried out at 20° F.-20° F., and 40° F. P-static failure is indicated by current fluctuations of +/−20% as a result of the breakdown of the topcoat of the transparency.

The transparency liner 304 can have a thickness of at least 0.5 mil, or at least 1 mil. The transparency liner 304 can have a thickness of up to 50 mil, or up to 40 mil, or up to 30 mil, or up to 20 mil. The transparency liner 304 can have a thickness in the range of from 0.5 mil to 50 mil, or in the range of from 1 mil to 50 mil, or in the range of from 1 mil to 40 mil, or in the range of from 1 mil to 30 mil, or in the range of from 1 mil to 20 mil.

The transparency film 300 can further comprise an inorganic active ply 310 over the adhesive layer 302. The inorganic active ply 310 can be over the transparency liner 304. The inorganic active ply 310 comprises a transparent conductive layer 314. A transparent conductive layer refers to a layer that typically has greater than 80% transmittance of visible light and can be formed from electrically conductive materials. The transparent conductive layer 314 can comprise gold, silver, copper, nickel, indium tin oxide, aluminum-doped zinc oxide, fluorine-doped tin oxide, palladium, platinum, alloys of palladium and silver, or combinations thereof. The transparent conductive layer 314 can electrically contact conductive layers of a functional coating 22 on the central viewing region 24 of the vehicle transparency 10. The transparent conductive layer 314 can be in direct contact with conductive layers of a functional coating 22. Alternatively, one or more intervening layers may be positioned between the transparent conductive layer 314 and conductive layers of a functional coating 22 with the transparent conductive layer 314 electrically contacting conductive layers of the functional coating 22 through the intervening layers. If intervening layers are present between the transparent conductive layer 314 and the conductive layers of the functional coating 22, the intervening layers may be sufficiently conductive such that the transparent conductive layer 314 electrically contacts conductive layers of the functional coating 22. The adhesive layer 302 may include a conductive UV-curable and/or pressure sensitive adhesive that comprises carbon nanotubes, graphene, dopants such as silver and/or gold, or a combination thereof. A conductive UV-curable and/or pressure sensitive adhesive can aid in the electrical contact between the transparent conductive layer 314 and conductive layers of the functional coating 22. The transparency film 300 may overlap the central viewing region 24 of the transparency 10 by at least 1 cm beyond the damage portion 28 in each direction to allow conductive continuity between the transparent conductive layer 314 and the conductive layers of the functional coating 22.

The inorganic active ply 310 can comprise biaxially textured polyethylene terephthalate. The inorganic active ply 310 can comprise a first dielectric layer 312. The first dielectric layer 312 can be under the transparent conductive layer 314. The inorganic active ply 310 can comprise a second dielectric layer 314. The second dielectric layer 316 can be over the transparent conductive layer 314. The inorganic active ply 310 can comprise a transparent conductive layer 314 and a dielectric layer 316 over the transparent conductive layer 314. The inorganic active ply 310 can comprise a first dielectric layer 312, a transparent conductive layer 314 over the first dielectric layer 312, and a second dielectric layer 316 over the transparent conductive layer 314. The inorganic active ply 310 can comprise a transparent conductive layer 314 positioned between at least two dielectric layers 312, 316. The dielectric layers 312, 316 of the inorganic active ply 310 can comprise titanium oxide, aluminum-doped zinc oxide, silicon oxide, tin oxide, indium-doped tin oxide, antimony-doped tin oxide, alumina, silicon nitrate, hafnium oxide, cerium oxide, yttrium oxide, yttrium-stabilized zirconia, zinc oxide, magnesium oxide, or a combination thereof. The dielectric layers 312, 316 of the inorganic active ply 310 can comprise the same material as each other. Alternatively, the dielectric layers 312, 316 of the inorganic active ply 310 can comprise different materials from each other.

The inorganic active ply 310 can comprise a patterned conductive layer or grid. As previously described, a patterned conductive layer refers to a layer or layers formed by passing a sputtering target over the transparency film 300 to apply the material(s) of the inorganic active ply 310 to the transparency film 300. As a result, the pattern for moving the target can be selected to apply more material and/or layers to a portion of the transparency film 300 and to apply less material and/or layers of the material(s) to other portions of the transparency film 300. Controlled movement of the sputtering target can be performed according to predetermined patterns to produce the inorganic active ply 310 having desired thickness and power density variability to obtain certain benefits. A patterned conductive grid refers to a grid formed from elongated wires or conductive traces embedded in or extending over the transparency film 300.

The inorganic active ply 310 can provide additional properties to the transparency film 300, such as, but not limited to, electromagnetic interference shielding, rain repellence and hydrophilicity, abrasion resistance, and/or chemical resistance. The transparency film 300 can comprise more than one inorganic active ply 310, such as at least two inorganic active plies 310, such as at least three inorganic active plies 310, or even more.

Referring to FIGS. 8-9 and 11-12, the transparency film 300 can further comprise a basecoat layer 306 over the adhesive layer 302. The basecoat layer 306 can be over the inorganic active ply 310. The basecoat layer 306 can be over the transparency liner 304. If a basecoat layer 306 is present, the basecoat layer 306 can be over the transparency liner 304, and the inorganic active ply 310 can be over the basecoat layer 306. Alternatively, if a basecoat layer 306 is present, the basecoat layer 306 can be over the inorganic active ply 310, and the transparency liner 304 can be over the basecoat layer 306. The basecoat layer 306 can comprise a silicone-based polymer, a silicon and epoxy based polymer, (meth)acrylate, an epoxy and acrylic based polymer, polyurethane, or a combination thereof.

The transparency film 300 can further comprise a polyurethane protective layer 308 over the transparency liner 304. The polyurethane protective layer 308 can comprise a polyurethane. For example, the polyurethane protective layer 308 can comprise a polyurethane that can be formed from a polyol and an isocyanate. The polyurethane protective layer 308 can be over the inorganic active ply 310. The polyurethane protective layer 308 can protect the transparency film 300 from mechanical and/or chemical damage from the surrounding environment.

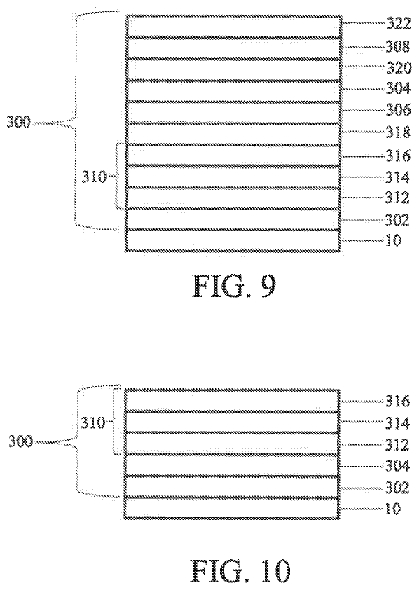

Referring to FIGS. 9 and 12, the transparency film 300 can comprise a rain repellant and/or hydrophobic layer 322. The rain repellant and/or hydrophobic layer 322 can be over the polyurethane protective layer 308. The rain repellant and/or hydrophobic layer 322 can comprise polydimethylsiloxane (PDMS), a hydrocarbon, a polyurethane, wax, and/or an inorganic material such as hafnium oxide, cerium oxide, yttrium-stabilized zirconia, or a combination thereof. The rain repellant and/or hydrophobic layer 322 can prevent rain, moisture, and other sources of water from penetrating and damaging the transparency film 300 and the vehicle transparency 10 thereunder.

The transparency film 300 can comprise a first tie coat layer 318. The first tie coat layer 318 can comprise an acrylic, a polyurethane, a polysiloxane, or a combination thereof. The first tie coat layer 318 can be over the transparency liner 304. The first tie coat layer 318 can be over the inorganic active ply 310. The first tie coat layer 318 can be under the basecoat layer 306. The first tie coat layer 318 can be over the transparency liner 304 and under the basecoat layer 306. The first tie coat layer 318 can be over the inorganic active ply 310 and under the basecoat layer 306. The first tie coat layer 318 can increase adhesion to adjacent layers of the transparency film 300 and/or increase flexibility of the transparency film 300. The increased adhesion and flexibility can help dissipate mechanical and thermal energy by movement of the transparency film 300 and other stressors. In this way, the first tie coat layer 318 can increase compatibility of the adjacent layers of the transparency film 300.

The transparency film 300 can comprise a second tie coat layer 320. The second tie coat layer 320 can comprise an acrylic, a polyurethane, a polysiloxane, or a combination thereof. The second tie coat layer 320 can be over the transparency liner 304. The second tie coat layer 320 can be under the polyurethane protective layer 308. The second tie coat layer 320 can be over the transparency liner 304 and under the polyurethane protective layer 308. If a second tie coat layer 320 is present, the previously-described polyurethane protective layer 308 can be over the second tie coat layer 320. The second tie coat layer 320 can be over the inorganic active ply 310. The second tie coat layer 320 can be over the inorganic active ply 310 and under the polyurethane protective layer 308. The second tie coat layer 320 can increase adhesion to adjacent layers of the transparency film 300 (e.g., the inorganic active ply 310, the transparency liner 304, and/or polyurethane protective layer 308) and/or increase flexibility of the transparency film 300. The second tie coat layer 320 can help to protect a layer positioned thereunder, such as the inorganic active ply 310 and/or the transparency liner 304.

The layers of the transparency film 300 can be provided in a variety of configurations and arrangements within the scope of the present disclosure determined, for example, based on functional requirements of particular vehicle transparencies, manufacturing requirements for the shell and/or transparency, or other considerations. As shown in FIG. 7, the transparency film 300 can comprise the adhesive layer 302, the inorganic active ply 310 over the adhesive layer 302, and the transparency liner 304 over the inorganic active ply 310. Alternatively, as shown in FIG. 8, the transparency film 300 can comprise the adhesive layer 302, the inorganic active ply 310 over the adhesive layer 302, the basecoat layer 306 over the inorganic active ply 310, the transparency liner 304 over the basecoat layer 306, and the polyurethane protective layer 308 over the transparency liner 304. The transparency film 300 can further comprise a rain repellant and/or hydrophobic layer 322 over the polyurethane protective layer 308. Alternatively, as shown in FIG. 9, the transparency film 300 can comprise the adhesive layer 302, the inorganic active ply 310 over the adhesive layer 302, the first tie coat layer 318 over the inorganic active ply 310, the basecoat layer 306 over the first tie coat layer 318, the transparency liner 304 over the basecoat layer 306, the second tie coat layer 320 over the transparency liner 304, the polyurethane protective layer 308 over the second tie coat layer 320, and the rain repellant and/or hydrophobic layer 322 over the polyurethane protective layer 308.

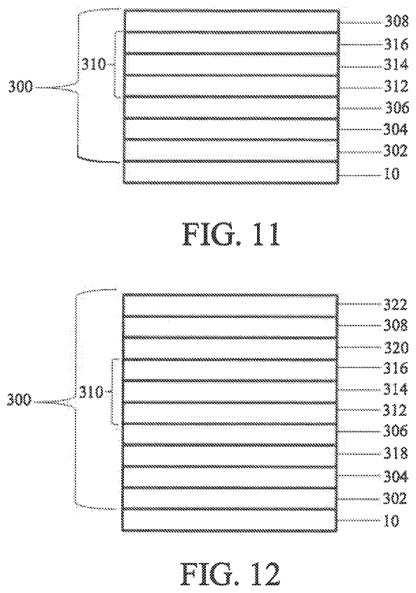

Alternatively, as shown in FIG. 10, the transparency film 300 can comprise the adhesive layer 302, the transparency liner 304 over the adhesive layer 302, and the inorganic active ply 310 over the transparency liner 304. Alternatively, as shown in FIG. 11, the transparency film 300 can comprise the adhesive layer 302, the transparency liner 304 over the adhesive layer 302, the basecoat layer 306 over the transparency liner 304, the inorganic active ply 310 over the basecoat layer 306, and the polyurethane protective layer 308 over the inorganic active ply 310. Alternatively, as shown in FIG. 12, the transparency film 300 can comprise the adhesive layer 302, the transparency liner 304 over the adhesive layer 302, the first tie coat layer 318 over the transparency liner 304, the basecoat layer 306 over the first tie coat layer 318, the inorganic active ply 310 over the basecoat layer 306, the second tie coat layer 320 over the inorganic active ply 310, the polyurethane protective layer 308 over the second tie coat layer 320, and the rain repellant and/or hydrophobic layer 322 over the polyurethane protective layer 308.

The transparency film 300 can be a flexible transparency film 300. A flexible transparency film 300 refers to a transparency film 300 that can bend, at standard temperature (i.e., 20° C.-25° C.) and pressure (e.g., 1 atm), to conform to a particular shape and/or curvature. While transparency film 300 can be made in a variety of shapes and sizes within the scope of the present disclosure, as previously described, the transparency film 300 generally can be shaped to correspond to portion of the vehicle transparency 10 the transparency film 300 is to be applied to, such as a damaged portion 28 of the vehicle transparency 10.

The transparency film 300 may not induce and/or can reduce optical distortion through the central viewing region 24 of the vehicle transparency 10 when adhered to the central viewing region 24 of the vehicle transparency 10. For example, the transparency film 300 may not induce and/or can reduce optical distortion through the central viewing region 24 of the vehicle transparency 10 such that, after the transparency film 300 has been adhered to the central viewing region 24 of the vehicle transparency 10, the vehicle comprising the vehicle transparency 10 can be safely operated and the central viewing region 24 of the vehicle transparency 10 meets optical standards and guidelines for operation of the vehicle. For example, the transparency film 300 may not substantially negatively affect, and can improve, light transmission, distortion and defraction, haze, and/or the like of the vehicle transparency 10. Substantially negatively affect refers to a negative change in an aforementioned property by 10% or more, where negative change is a change in the quantified value of a property that moves the quantified value of the property away from the desired quantified value of the property for the vehicle transparency 10.

The transparency film 300 can be configured to be adhered to the damaged portion 28 of the central viewing region 24 of the vehicle transparency 10. The transparency film 300 can have a size that is larger than the size of the damaged portion 28 of the central viewing region 24 of the vehicle transparency 10. By adhering the transparency film 300 to the damaged portion 28 of the central viewing region 24 of the vehicle transparency 10, the transparency film 300 can repair the damaged portion 28 of the central viewing region 24 of the vehicle transparency 10. For example, a use of the transparency film 300 can be to repair the vehicle transparency 10. The transparency film 300 may not induce and/or can reduce optical distortion through the damaged portion 28 of the central viewing region 24 of the vehicle transparency 10 compared to an optical distortion through the damaged portion 28 of the central viewing region 24 of the vehicle transparency 10 without the transparency film 300. The transparency film 300 can repair and provide conductive continuity of a functional coating 22 at the damaged portion 28 of the central viewing region 24 of the vehicle transparency 10.

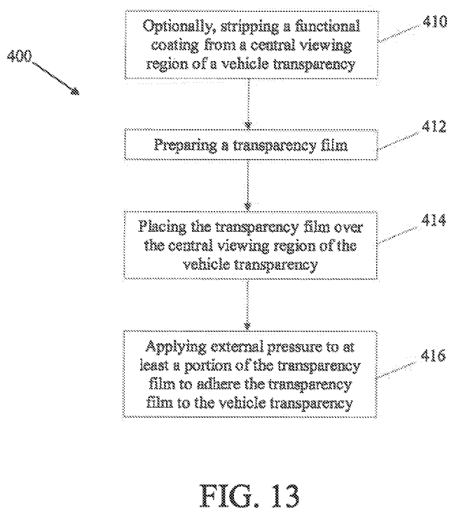

FIG. 13 illustrates steps of a method 400 for applying the transparency film 300 to a vehicle transparency 10 comprising a central viewing region 24 and peripheral regions 26. The central viewing region 24 of the vehicle transparency 10 may be coated or uncoated prior to placing of the transparency film 300. As previously described, the transparency film 300 can be applied to the vehicle transparency 10 to repair the damaged portion 28 of the central viewing region 24 of the vehicle transparency 10 without removing the vehicle transparency 10 from the vehicle. This allows for the damaged portion 28 of the central viewing region 24 of the vehicle transparency 10 to be repaired at any time when the vehicle transparency 10 is accessible, and does not require expensive and time consuming processes of removing the vehicle transparency 10 and moving the vehicle transparency 10 to a repair location or replacing the vehicle transparency 10 entirely.

With reference to FIG. 13, when a functional coating 22 is present, the method 400 optionally comprises, at step 410, initially stripping a functional coating 22 from the central viewing region 24 in order to prepare the transparency 10 to be repaired. The functional coating 22 may be stripped from the central viewing region 24 of the vehicle transparency 10 by various methods, such as with acid and/or by a mechanical tool.

At step 412, the method 400 further comprises preparing a transparency film 300. The transparency film 300 can be any transparency film 300 as described above. The transparency liner 304 of the transparency shell 100 can be flexible such that the transparency film 300 can conform to the curvature of the outer surface 14 of the vehicle transparency 10. During the preparing step 412, the layer(s) of the transparency film 300 may be sequentially applied over the transparency liner 304 to obtain the transparency film 300 with layers in a specified order. Layer(s) of the transparency film 300 that are positioned under the transparency liner 304 may be sequentially applied under the transparency liner 304. The layers of the transparency film 300 may be applied to a transparency liner 304 in any way known in the art. The polyurethane protective layer 308, the basecoat layer 306, the first tie coat layer 318, and/or the second tie coat layer 320 may each independently be applied to the transparency liner 304, either over or under depending on the specific positioning of the layer, using any technique known in the art. The polyurethane protective layer 308, the basecoat layer 306, the first tie coat layer 318, and/or the second tie coat layer 320 may each independently be applied to the transparency liner 304, cither over or under depending on the specific positioning of the layer, by flow coating technique. The inorganic active ply 310 and layers thereof may be applied to the transparency liner 304, either over or under depending on the specific position of the ply and/or layer, using any technique known in the art, such as magnetic sputter vacuum deposition (MSVD). The adhesive layer 302 may be applied under the transparency liner 304 using any technique known in the art, such as roll coating, flow coating, brushing, and/or the like.

At step 414, the method 400 further comprises placing the transparency film 300 over the prepared central viewing region 24 of the vehicle transparency 10. The placing of the transparency film 300 may comprise placing the transparency film 300 over an uncoated central viewing region 24 and peripheral regions 26 of the vehicle transparency 10. The placing of the transparency film 300 may comprise placing the transparency film 300 over a functional coating 22 on the central viewing region 24 and peripheral regions 26 of the vehicle transparency 10. The placing of the transparency film 300 may comprise placing transparency film 300 over the central viewing region 24 and peripheral regions 26 of the vehicle transparency 10, where a functional coating 22 had been previously stripped from the central viewing region 24 of the vehicle transparency 10 prior to the placing of the vehicle transparency 10.

Placing the transparency film 300 can comprise placing the film 300 over a damaged portion 28 of the central viewing region 24 of the vehicle transparency 10. The placing of the transparency film 300 over the damaged portion 28 of the central viewing region 24 of the vehicle transparency 10 may not induce and/or may reduce optical distortion through the damaged portion 28 of the central viewing region 24 compared to an optical distortion through the damaged portion 28 of the central viewing region 24 of the vehicle transparency 10 prior to the placing of the transparency film 300. The transparency film 300 may repair and provide conductive continuity of a functional coating 22 at the damaged portion 28 of the central viewing region 24 of the vehicle transparency 10.

At step 416, the method 400 further comprises applying external pressure to at least a portion of the transparency film 300 to adhere the transparency film 300 to the vehicle transparency 10. The adhering the transparency film 300 to the vehicle transparency 10 may not induce and/or can reduce optical distortion through the central viewing region 24 of the vehicle transparency 10.

Illustrating the disclosure are the following examples, which, however, are not to be considered as limiting the disclosure to their details. Unless otherwise indicated, all parts and percentages in the following examples, as well as throughout the specification, are by weight.

Coupon preparation for repair film. A repair film stack was prepared having the following layers, and the pressure sensitive adhesive was used to bond the repair film stack to a substrate to prepare a coupon including the repair film stack:

Topcoat
Polyurethane Liner
Performance Metal Layer
Mylar
Pressure Sensitive Adhesive
Canopy Surface/Substrate

The topcoat can be a polyurethane composition having a thickness of 1 mm to 4 mm. The polyurethane liner can be a polyurethane composition having a thickness of 2 mm to 15 mm thick. The pressure sensitive adhesive layer can be an acrylic composition or polyurethane composition having a thickness of 1 mm to 15 mm

Optics. The pressure sensitive adhesive side of the repair film stack was applied to a 0.25″ thick stretched acrylic substrate coupon (3″×6″) and optics were observed according to ASTM D1003 using BYK Haze-Gard Plus instrument to measure light transmittance (LT) and haze. Haze measures the clearness and transparency of the film while visible light transmittance (LT) measures the amount of visible light transmitted through the sample. Shimadzu UV-Vis-NIR was used to measure NVIS values. The LT, haze, and NVIS measurements are recorded as an average of three spots taken over the coupon, resulting in an LT average of 80.9%, a haze average of 1.77%, and an NVIS average of 75.98%.

Peel Adhesion for current PSA (3M PSA). Peel adhesion testing was performed to understand adhesion of PSA to substrate. Coupon preparation for peel adhesion includes stretched acrylic coupon backed with Mylar and PSA with aluminum metal bar to provide stiffness. The coupon was 12″ in length and had an exposed peel region of 1″ defined by green tape. Peel adhesion testing was performed using a 90 degree roller peel test. Results demonstrated good bonding with the data presented in the table below:

| Temperature (° F.) | Backing | Peel (PLI) |
|---|---|---|
| 65 | Aluminum | 2.67 |
| room temperature | Aluminum | 15.276 |
| 164 | Aluminum | 5.863 |

Rain Erosion (<10% damage). Rain erosion was carried out on a 1″×1″ square coupon and exposed to simulated rainfall at a speed of 576 miles per hour (mph) at a 30 degree angle. The coupons were inspected for degradation to the film after 60 minutes with no degradation observed in the film. Supersonic rain erosion was further carried out by UDRI at 750 mph at a 30 degree angle with no visually apparent damage or delamination.

Humidity and solar radiation (QUV 313 with edge sealant)-10 week exposure. A 3″×6″ coupon having the edges sealed with a sealant was prepared and exposed to cycles of accelerated weathering in a QUV chamber for a 10 week exposure. QUV was conducted with UVB-313 lamps at 120F with alternating cycles of 7 hours UV at an irradiance of 0.49 W/(m\hat{ }2*nm) and 5 hours of condensation (no UV). Visible light transmittance and haze were observed weekly with minimal weathering damage after 10 weeks. The experimental data are shown in the table below:

| Week | 0 | 1 | 10 |
|---|---|---|---|
| VLT (%) | 80.9 | 80.7 | 80.2 |
| Haze (%) | 1.77 | 2.04 | 3.32 |
| NVIS (%) | 75.98 | 76.18 | 75.88 |

Humidity (1000 hours with Al tape edge seal). Coupons were exposed to humidity for 1000 hours at conditions of 100.0% relative humidity and a temperature of 105 F. The edges were sealed with aluminum tape to prevent moisture ingress through the sides of the coupon. Haze and Visible Light Transmittance (VLT) were measured after 1000 hours. Delamination was also inspected and none was observed. The following experimental data were obtained:

| Humidity | 0 weeks | 6 weeks |
|---|---|---|
| VLT (%) | 76.9 | 76.4 |
| Haze (%) | 1.37 | 1.6 |

Chemical resistance testing was performed using a droplet test with exposure lengths of 30 minutes using the fluids listed in the table below. All fluids were wiped off with dry Rymple cloth after 30 minutes and the test substrate was left at ambient condition overnight. Light transmittance and haze measurements were taken after and recorded in the table below:

| | Before | Before | After | After |
|---|---|---|---|---|
| | LT | H | LT | H |
| Fluids (30 minute exposure) | (%) | (%) | (%) | (%) |
| Jet Fuel JP-8 + 100 | 73.3 | 1.37 | 73.3 | 1.91 |
| Turbine Lubricating Oil (MIL- | 71.8 | 3.04 | 71.8 | 3.4 |
| PRF-23699) | | | | |
| Coolant (MIL-PRF-87252) | 71.9 | 1.63 | 71.4 | 3.16 |
| Runway Deicing (AMS 1435) | 72.7 | 1.83 | 72.6 | 6.25 |
| Aircraft Deicing (AMS 1424) | 72.9 | 2.54 | 73.2 | 2.16 |
| Methyl Ethyl Ketone (ASTM | 72 | 1.35 | 72.1 | 1.59 |
| D740) | | | | |
| Cleaning Fluid (MIL-PRF-87937) | 71.9 | 2.11 | 71.4 | 2.89 |
| Hydraulic Fluid (MIL-PRF-83282) | 72.9 | 1.86 | 72.8 | 8.51 |

Sand and Dust+QUV (5 weeks). 3″×6″ coupons were prepared with aluminum-tape edge seal. Two sets of coupons were prepared-one with a bare stretched acrylic substrate, and one with the film stack applied to the bare-acrylic substrate. The coupons were first exposed to 5 weeks of QUV conditioning with UVB-313 lamps at 120F with alternating cycles of 7 hours UV at an irradiance of 0.49 W/(m\hat{ }2*nm) and 5 hours of condensation (no UV). Sand and dust exposure was performed at UDRI. The sample was positioned at 30 deg angle. The exposure testing consisted of sand of 230 mesh with a cloud concentration of 0.01 gm/m3, speed of 400 knots for a duration of 4 minutes. Light transmittance and haze measurements were observed and compared with the bare stretched acrylic substrate. The delta haze of the coated samples was lower than the delta haze of the uncoated samples. The delta haze was determining by comparing the haze value prior to QUV conditioning and sand and dust exposure to the haze value following such conditioning and exposure wherein delta haze=(initial haze−exposed haze)/initial haze*100%. The following experimental data were obtained:

| Post Sand Dust | Delta Haze (%) |
|---|---|
| Film Stack | 34.9 |
| Bare Substrate | 75.4 |

Salt Fog—ASTM G85 annex. Salt fog coupons were prepared on 6″×6″ films applied to stretched acrylic substrate and edge-sealed with aluminum tape. Each coupon was tested in accordance with ASTM G85 annex A4 cycle with sodium chloride for 336 hours. The panels were edge-protected to prevent moisture penetration. The coupons were inclined at 30 degrees from vertical. Haze and LT measurements were observed before and after exposure. NTS performed the salt fog exposure. The following experimental data were obtained:

| Salt Fog | Pre-Test | Post-Test |
|---|---|---|
| LT (%) | 75.3 | 69 |
| Haze (%) | 1.42 | 3.97 |

Large scale film application success. Large scale applications were successfully performed on an F-18 windshield and a T-7a windshield which have a cylindrical shape. The films were applied using soap, water, and/or rapid tac as wetting agents for the PSA to the canopy.

Whereas particular examples and embodiments of this disclosure have been described above for purposes of illustration, it will be evident to those skilled in the art that numerous variations of the details of the present disclosure may be made without departing from the disclosure as defined in the appended claims.

1. A transparency shell for applying to a vehicle transparency comprising a central viewing region of the vehicle transparency and a peripheral region at least partially around the central viewing region, the transparency shell comprising:
a bonding layer comprising a polyurethane interlayer, a polyvinyl interlayer, a UV-curable adhesive, or a pressure sensitive adhesive;
a transparency liner comprising a polycarbonate, poly(methyl methacrylate), polyurethane, glass, polyethylene terephthalate, biaxially textured polyethylene terephthalate, glycol-doped polyethylene terephthalate, or a combination thereof over the bonding layer; and
an inorganic active ply over the bonding layer comprising a transparent conductive layer,
wherein the bonding layer of the transparency shell can be configured to be adhered or laminated to the central viewing region of the vehicle transparency.

2. The transparency shell of claim 1, wherein the transparency shell comprises a curvature that corresponds to a curvature of an outer surface of the central viewing region of the vehicle transparency.

3. The transparency shell of claim 1, wherein the transparency shell does not induce optical distortion through the central viewing region of the vehicle transparency.

4. The transparency shell of claim 1, wherein the vehicle transparency comprises an aircraft windshield and/or canopy.

5. The transparency shell of claim 1, further comprising a basecoat layer over the bonding layer, wherein the basecoat layer comprises a silicone-based polymer, a silicon and epoxy based polymer, (meth)acrylate, an epoxy and acrylic based polymer, polyurethane, or a combination thereof.

6. The transparency shell of claim 1, wherein the transparent conductive layer comprises gold, silver, copper, nickel, indium tin oxide, aluminum-doped zinc oxide, fluorine-doped tin oxide, palladium, platinum, alloys of palladium and silver, or a combination thereof.

7. (canceled)

8. The transparency shell of claim 1, wherein the inorganic active ply further comprises a dielectric layer over the transparent conductive layer.

9. The transparency shell of claim 1, wherein the inorganic active ply comprises the transparent conductive layer positioned between two dielectric layers.

10. The transparency shell of claim 8, wherein the dielectric layer of the inorganic active ply comprises titanium oxide, aluminum-doped zinc oxide, silicon oxide, tin oxide, indium-doped tin oxide, antimony-doped tin oxide, alumina, silicon nitrate, hafnium oxide, cerium oxide, yttrium oxide, yttrium-stabilized zirconia, zinc oxide, magnesium oxide, or a combination thereof.

11. The transparency shell of claim 1, wherein the inorganic active ply comprises a patterned conductive grid.

12. The transparency shell of claim 1, further comprising a polyurethane protective layer over the transparency liner.

13. The transparency shell of claim 12, further comprising a rain repellant and/or hydrophobic layer over the polyurethane protective layer.

14. The transparency shell of claim 1, wherein the transparency shell comprises:
a basecoat layer over the transparency liner;
a polyurethane protective layer over the inorganic active ply.

15. The transparency shell of claim 14, further comprising a first tie coat layer over the transparency liner and under the basecoat layer.

16. The transparency shell of any of claim 15, further comprising a second tie coat layer over the inorganic active ply and under the polyurethane protective layer.

17. The transparency shell of any of claim 14, wherein the transparency liner comprises a thickness in the range of from 1 mil to 200 mils.

18. The transparency shell of claim 1, wherein the vehicle transparency comprises a damaged portion within the central viewing portion, and wherein the transparency shell can be configured to be adhered or laminated to the damaged portion of the central viewing region of the vehicle transparency.

19. The transparency shell of claim 18, wherein the transparency shell does not induce and/or reduces optical distortion through the damaged portion of the central viewing region of the vehicle transparency compared to an optical distortion through the damaged portion of the central viewing region of the vehicle transparency without the transparency shell.

20. A vehicle transparency comprising a central viewing region and a peripheral region at least partially around the central viewing region covered with the transparency shell of claim 1.

21. The vehicle transparency of claim 20, comprising a first sheet and a second sheet joined together by an interlayer or a UV-curable and/or pressure sensitive adhesive.

22-82. (canceled)
